(19) United States
(12) Patent Application Publication
(10) Pub. No.: US 2025/0307169 A1
(43) Pub. Date: Oct. 2, 2025

(54) APPARATUSES, METHODS, SYSTEMS, AND COMPUTER PROGRAM PRODUCTS FOR SIDECAR CACHE INVALIDATIONS AND BROADCASTING

(71) Applicant: ATLASSIAN PTY LTD, Sydney (AU)

(72) Inventors: Nhu An Nguyen, Sydney (AU); David Gareth Connard, Sydney (AU)

(21) Appl. No.: 19/092,572

(22) Filed: Mar. 27, 2025

Related U.S. Application Data
(60) Provisional application No. 63/571,678, filed on Mar. 29, 2024.

(51) Int. Cl. G06F 12/0891

(52) U.S. Cl. CPC G06F 12/0891

(57) ABSTRACT

Apparatuses, methods, systems, and computer program products for sidecar cache invalidations and broadcasting is provided. A cache invalidation message may be received. The cache invalidation message may be published to a cache invalidation repository based on a region identifier of a plurality of region identifiers associated with the cache invalidation repository. A cache invalidation polling request may be received from a service associated with the region identifier. The cache invalidation message may be provided to the service associated with the region identifier.

### CROSS-REFERENCE TO RELATED APPLICATIONS

This application claims priority to U.S. Provisional Patent Application No. 63/571,678, filed Mar. 29, 2024, the contents of each of which is incorporated herein by reference in its entirety.

### BACKGROUND

A sidecar architecture may be leveraged in various systems, including systems employing several services. Applicant has identified many deficiencies and problems associated with systems that support sidecar cache invalidations. Through applied effort, ingenuity, and innovation, these identified deficiencies and problems have been solved by developing solutions that are in accordance with the embodiments of the present invention, many examples of which are described in detail herein.

### BRIEF SUMMARY

In accordance with one aspect of the present disclosure, a computer-implemented method for sidecar cache invalidations in a tenant context service architecture is provided, the computer-implemented method comprising receiving a cache invalidation message; publishing the cache invalidation message to a cache invalidation repository based on a region identifier of a plurality of region identifiers associated with the cache invalidation repository; receiving a cache invalidation polling request from a service associated with the region identifier; and providing, the cache invalidation message to the service associated with the region identifier.

In some embodiments, receiving the cache invalidation polling request from the service comprises receiving the cache invalidation polling request from a sidecar associated with the service.

In some embodiments, the computer-implemented method further comprises broadcasting a cache key currently stored by the sidecar to at least a second sidecar associated with the service.

In some embodiments, the computer-implemented method further comprises receiving a sidecar registration request comprising the region identifier prior to receiving the cache invalidation polling request.

In some embodiments, the sidecar registration request further comprises a client identifier, wherein the client identifier comprises a role identifier and a role session name.

In some embodiments, each region identifier of the plurality of region identifiers is associated with at least one dedicated cache invalidation repository for the region identifier. In some embodiments, the service comprises a tenant context service sidecar.

In some embodiments, receiving the cache invalidation message comprises retrieving the cache invalidation message from a cache invalidation stream, wherein the cache invalidation message is stored in a memory for at least a predetermined period before publishing to the cache invalidation repository.

In accordance with another aspect of the present disclosure, an apparatus for sidecar cache invalidations in a tenant context service architecture is provided, the apparatus comprising at least one processor and at least one memory including program code, the at least one memory and the program code configured to, with the at least one processor, cause the apparatus to at least receive a cache invalidation message; publish the cache invalidation message to a cache invalidation repository based on a region identifier of a plurality of region identifiers associated with the cache invalidation repository; receive a cache invalidation polling request from a sidecar associated with a service, wherein the service is associated with the region identifier; and provide, the cache invalidation message to the service associated with the region identifier.

In some embodiments, the at least one memory and the program code is further configured to, with the at least one processor, cause the apparatus to at least broadcast a cache key currently stored by the sidecar to at least a second sidecar associated with the service.

In some embodiments, the at least one memory and the program code is further configured to, with the at least one processor, cause the apparatus to at least receive a sidecar registration request comprising the region identifier prior to receiving the cache invalidation polling request.

In some embodiments, the sidecar registration request further comprises a client identifier, wherein the client identifier comprises a role identifier and a role session name.

In some embodiments, each region identifier of the plurality of region identifiers is associated with at least one dedicated cache invalidation repository for the region identifier.

In some embodiments, the service comprises a tenant context service sidecar.

In some embodiments, receiving the cache invalidation message comprises retrieving the cache invalidation message from a cache invalidation stream, wherein the cache invalidation message is stored in a memory for at least a predetermined period before publishing to the cache invalidation repository.

In accordance with another aspect of the present disclosure, at least one non-transitory computer-readable storage medium for sidecar cache invalidations in a tenant context service architecture is provided, the at least one non-transitory computer-readable storage medium having computer coded instructions configured to, when executed by at least one processor receive a cache invalidation message from a cache invalidation message stream; publish the cache invalidation message to a cache invalidation repository based on a region identifier of a plurality of region identifiers associated with the cache invalidation repository; receive a cache invalidation polling request from a service associated with the region identifier; and provide, the cache invalidation message to the service associated with the region identifier.

In some embodiments, receiving the cache invalidation polling request from the service comprises receiving the cache invalidation polling request from a sidecar associated with the service.

In some embodiments, the computer coded instructions further configured to, when executed by the at least one processor broadcast a cache key currently stored by the sidecar to at least a second sidecar associated with the service.

In some embodiments, the computer coded instructions further configured to, when executed by the at least one processor receive a sidecar registration request comprising the region identifier prior to receiving the cache invalidation polling request.

In some embodiments, each region identifier of the plurality of region identifiers is associated with at least one dedicated cache invalidation repository for the region identifier.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1A provides an example tenant context service (TCS) sidecar cache invalidation system architecture within which at least some embodiments of the present disclosure may operate.

FIG. 1B illustrates an operational example of an implementation of at least a portion of a TCS sidecar cache invalidation system in accordance with at least some embodiments of the present disclosure.

FIG. 2 illustrates a block diagram of an apparatus in accordance with at least some embodiments of the present disclosure.

FIG. 3 is a block diagram of an example client computing device structured in accordance with at least some embodiments of the present disclosure.

FIG. 4 illustrates a visualization of an example data environment for TCS sidecar cache invalidation in accordance with at least some embodiments of the present disclosure.

FIG. 5 illustrates a block diagram of TCS sidecar registration process in accordance with at least some example embodiments of the present disclosure.

FIG. 6 is a flow chart diagram of an example process for TCS sidecar cache invalidation in accordance with at least some embodiments of the present disclosure.

### DETAILED DESCRIPTION OF SOME EMBODIMENTS

Some embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” (also designated as “/”) is used herein in both the alternative and conjunctive sense, unless otherwise indicated. The terms “illustrative,” “example,” and “exemplary” are used to be examples with no indication of quality level. Like numbers refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Overview

Some embodiments of the present invention address technical problems associated with sidecar cache invalidation, particularly sidecar cache invalidations in a tenant context service (TCS) architecture employing several services. Traditional sidecar cache invalidation techniques may utilize notification services, such as simple notification service (SNS) to facilitate sidecar cache invalidations by communicating cache invalidations to SNS topics associated with each service compute node. In this regard, in a system (e.g., federated system) employing several services, the number of SNS messages required for sidecar cache invalidations in such systems may be substantial and result in high latency, high network traffic, and inefficiencies in the system. Further, these large number of SNS messages required would result in high cost. For example, a system employing hundreds of services would have thousands of compute nodes and require thousands of SQS queues, thus, increasing cost.

Some embodiments of the present disclosure are directed to a TCS sidecar cache invalidation computing system that leverages cache invalidation techniques configured to address the above deficiencies and problems, and other deficiencies and problems associated with sidecar cache invalidations. The below disclosed system is configured to leverage cache invalidation repositories distributed across several regions to communicate cache invalidations and leverage polling techniques to retrieve the cache invalidations. Example embodiments receive cache invalidation messages from cache invalidation stream, publish the cache invalidation messages to one or more cache invalidation repositories (which may or may not be across regions). In example embodiments, sidecars (e.g., TCS sidecars) poll cache invalidation repositories in associated region for cache invalidation messages, receive the cache invalidation messages and perform sidecar cache invalidations based on the received cache invalidation messages. In some example embodiments, sidecars broadcast cache keys and cryptor keys to other sidecars, between application nodes, and/or between instances in a service.

Sidecar cache invalidation techniques disclosed herein produce a number of technical benefits. For example, by publishing cache invalidation messages to invalidation cache repositories and providing for sidecars to poll for each cache invalidation message, example embodiments herein obviate the need to communicate cache invalidations individually and directly to each sidecar whenever a tenant record is updated, which in turn, improves latency and efficiency in systems employing a sidecar architecture while also reducing cost.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “client computing entity” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” refers to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “multi-layer service-oriented platform” refers to a complex network computing environment associated with a multitude of computing devices, applications, services, and microservices. For example, in some embodiments, a multi-layer service-oriented platform includes dozens of applications that are supported by 1000+ services operating within a cloud-based platform. Example multi-layer service-oriented platforms may comprise a federated network of computing devices, and/or a plurality of database platforms (e.g., servers, hard-drives, etc.). Applications and services or microservices of example multi-layer service-oriented platforms may be hosted by internal resources or external resources. Multi-layer service-oriented platforms may support multiple applications that are configured for the collection of information (e.g., in the form of application data objects), storing of information collected, managing of information collected, processing of information collected and/or providing other services, individually or collectively, for the benefit of a user. Each software application may include a number of features, with many features (e.g., user authentication features) shared between multiple software applications. Other features may be supported only by one associated software application or a defined subset of software applications. A given multi-layer service-oriented platform could support hundreds of software applications and hundreds of thousands of features. Those applications and features could be supported by thousands of services and microservices that exist in vast and ever-changing interdependent layers. Software development teams may release code updates that change various software services, launch new software services, change existing features of existing software applications, add new software applications, add new software application features to existing software applications, and/or the like. Non-limiting example of applications and/or tools that may be included in a multi-layer service-oriented platform, include Jira Software® by Atlassian, Inc. Jira Service Management® by Atlassian Inc., Confluence® by Atlassian, Inc., JIRA Service Desk by Atlassian®., Inc.

The term “internal resource” refers to a software program, application, platform, or service that is configured by an organization (e.g., an enterprise owner of a multi-layer service-oriented platform) to provide functionality to another one or more of the software programs, applications, platforms, or services operating on a multi-layer service-oriented platform, either directly or indirectly, through one or more other services. Internal resources operate on a compiled code base and/or use data repositories that are at least partially shared by other software programs, applications, or services of the multi-layer service-oriented platform. In some embodiments, application code bases, service code bases, and code bases that support an internal resource are hosted on common servers or using computing devices operating within a common intranet or network.

The term “external resource” refers to a software program, application, platform, or service that is configured to communicate with applications, services, software programs, and/or devices of a multi-layer service-oriented platform but which operates on a compiled code base that is separate from code bases of the multi-layer service-oriented platform. In some embodiments, communications between an external resource and an application or service calling the external resource takes place through a firewall and/or other network security features of the multi-layer service-oriented platform. The external resource operates on a compiled code base or repository that is separate and distinct from that which supports the application or service of the multi-layer service-oriented platform calling the external resource. The external resource is generally considered outside of the ecosystem of internal resources that are generated, operated, maintained, and controlled by developers of the multi-layer service-oriented platform.

The terms “service,” “microservice,” and similar terms refer to a software functionality or a set of software functionalities, such as the retrieval of specified information or the execution of a set of operations, with a purpose that different clients can reuse for their respective purposes, together with the policies that should control its usage, for example, based on the identity of the client (e.g., a user, requesting entity identifier, an application, another service, etc.) requesting the service. Additionally, a service may support, or be supported by, at least one other service via a service dependency relationship. For example, a translation application stored on a smartphone may call a translation dictionary service at a server in order to translate a particular word or phrase between two languages. In such an example the translation application is dependent on the translation dictionary service to perform the translation task. In some embodiments, a service is offered by one computing device over a network to one or more other computing devices. Additionally, the service may be stored, offered, and utilized by a single computing device to local applications stored thereon and in such embodiments a network would not be required. In some embodiments, services may be accessed by other services via a plurality of Application Programming Interfaces (APIs), for example, JavaScript Object Notation (JSON), Extensible Markup Language (XML), Simple Object Access Protocol (SOAP), Hypertext Markup Language (HTML), the like, or combinations thereof. In some embodiments, services may be configured to capture or utilize database information and asynchronous communications via message queues (e.g., Event Bus). Non-limiting examples of services include an open source API definition format, an internal developer tool, web based HTTP services, databased services, and asynchronous message queues which facilitate service-to-service communications. In some embodiments, a service can represent an operation with a specified outcome and can further be a self-contained software program. In some embodiments, a service from the perspective of the client (e.g., another service, application, etc.) can be a black box meaning that the client need not be aware of the service's inner workings. Additionally, a service may be configured to provided discrete software functionality, where the discrete software functionality provided by a service specifically serves a particular purpose or accomplishes a particular task. Additionally, a service may comprise a collection of computing nodes running the same software.

The terms “tenant context service,” “TCS” or similar terms refer to a service that is configured to provide a view of tenant metadata. For example, a TCS may be configured to provide low-latency access to application-specific views of the current tenant state data stored in a catalogue service. In some embodiments, a TCS lookup is performed to serve a client request. For example, a TCS may be called multiple times in the path of a web request associated with an application including, but not limited to cloud-based applications. A TCS may provide a highly-available, read-optimized view of a catalogue of tenant metadata. For example, a TCS may be a key-value store providing access to view current tenant state data stored in a catalogue service (e.g., a service/microservice configured to manage and provide access to a collection of items, resources, or metadata such as item, resources, or metadata associated with tenant(s) of a software application or platform such as, for example, a multi-layer service-oriented platform)). In some embodiments, a TCS is configured to ingest updated tenant records to a tenant record repository (e.g., embodied as a NoSQL database such as AWS DynamoDB, or the like) in response to changes to the tenant records. In some embodiments, the updated tenant records may be fetched or otherwise retrieved from the tenant record repository via a representational state transfer (REST) API, or the like. In some embodiments, a TCS is associated with a particular region (e.g., identified by a region identifier) of a plurality of regions. In some embodiments, a TCS may be associated with one or more TCS sidecars and may configured to publish invalidation messages to one or more cache invalidation repositories based on the TCS sidecars registered with the TCS. A TCS cache invalidation server (e.g., associated with a TCS) may be configured to make cross-region calls to publish invalidation messages, such that the cache invalidation messages may be retrieved or otherwise accessed by a TCS sidecar registered with the TCS. In some embodiments, a TCS includes an application load balancer (e.g., a network component that distributes incoming application traffic across multiple servers or computing resources), a tenant record repository, a plurality of web server nodes (e.g., for client traffic), invalidation broadcaster nodes (e.g., to publish cache invalidation messages to cache invalidation repositories) and/or the like.

The term “invalidation broadcaster node”, “invalidation broadcaster” or similar terms, refers to specialized components within a cache system, configured to propagate cache invalidation across the system, such as to cache invalidation repositories thereof. Invalidation broadcaster nodes may be configured to facilitate maintaining data consistency and ensuring that cached information remains up-to-date across multiple caches or application instances. For example, invalidation broadcaster nodes may be configured to publish new file versions (e.g., updated file versions comprising tenant data) into cache invalidation repositories. In some examples, invalidation broadcaster nodes may be implemented as dedicated processes or services running on one or more servers (e.g., TCS sidecar invalidation servers 106A-N) within the system.

The term “tenant record” refers to a data structure that represents and stores information about a specific tenant associated with a software application or platform such as, for example, a multi-layer service-oriented platform. In some examples, a tenant record may be implemented as a structured data object corresponding to a database table or document in a database storage system such as tenant record repository.

As used herein the term “tenant record repository” refers to a storage and management system for storing and managing tenant records. A tenant record repository may be associated with and/or comprise a component of a software application or platform such as, for example, a multi-layer service-oriented platform. In some examples, a tenant record repository may serve as the authoritative source for tenant data. In some examples, a tenant record repository may be implemented as a dedicated database or data store such as, for example relational databases or the like.

The term “tenant” refers to a customer, user group, or organization that shares access to a software application(s) or platform such as, for example, a multi-layer service oriented platform. For example, a tenant may comprise a customer, user group, or organization that shares the same application instance and which may maintain its own data and configuration settings.

The term “current state data” refers to information that represent the current status, configuration, and/or operational data specific to a particular tenant such as for example, a tenant of a multi-layer service-oriented platform.

The term “web server node” refers to a specialized application node dedicated to handling HTTP requests, serving web content, and or performing other functions associated with a web application. For example, a web server node may be configured for processing incoming client requests, executing server-side logic, delivering web pages or API responses, and/or the like. In some examples, a web server node may be implemented as a software process running on a physical or virtual machine (e.g., within a containerized or cloud environment, or the like).

The term “application node” refers to a discrete computational unit within an application architecture. An application node may represent an individual instance of an application or a specific component of a larger system, designed to perform particular function or handle a portion of the overall load. In some examples, an application node may be implemented as a standalone process, container, or virtual machine running on a physical or virtual server.

The term “region identifier” refers to one or more data items or elements by which a region (e.g., geographical area) may be uniquely identified. In some embodiments, the region identifier is a TCS region identifier that uniquely identifies a TCS region (e.g., a TCS geographical area). The region identifier may include, for example, one or more of Internet Protocol (IP) addresses associated with a service, Uniform Resource Locators (URLs) associated with a service, numerical characters, alphabetical characters, alphanumeric codes, American Standard Code for Information Interchange (ASCII) characters, encryption keys, identification certificates, the like, or combinations thereof. Not limiting examples of a TCS region includes us cast-1, us cast-2 us-west 1, and/or the like.

The term “TCS region” refers to a geographical area hosting one or more computing resources (e.g., storage, compute, and/or the like) separate from computing resources hosted by other geographical areas. For example, each TCS region may be a separate geographical area hosting cloud computing resources. In some examples, the computing resources hosted by a TCS region may be distributed across a plurality of isolated locations within the geographical area associated with the TCS region. In some embodiments, each TCS region is independent of other TCS regions. In some embodiments, a TCS region includes or is associated with one or more cache invalidation repositories configured for facilitating sidecar cache invalidation process. For example, a cache invalidation repository associated with a particular TCS region may be leveraged to facilitate TCS cache invalidation for a TCS sidecar served by the TCS region or otherwise associated with the TCS region.

The term “cache invalidation repository” refers to a repository configured to store objects, data, and/or the like. In some embodiments, the cache invalidation repository is configured to store cache invalidation messages. In some embodiments, a cache invalidation repository is configured to receive cache invalidation messages published by a TCS. A cache invalidation repository may be configured to receive cache invalidation polling request from a service (e.g., TCS sidecar thereof) for cache invalidation messages published by a TCS (e.g., TCS cache invalidation server thereof) and provide the cache invalidation messages to the TCS sidecar associated with the service. In some embodiments, the cache invalidation repository is configured to receive cache keys (e.g., unique identifier used to store and retrieve data in a cache/cache system) and/or cryptor keys (e.g., cryptographic information used to secure and protect data, such as data stored in a cache/cache system) broadcast by a TCS sidecar in the same region or the same service group. An example of a cache invalidation repository is an AWS S3 object-oriented container (e.g., S3 bucket). For example, in some example implementations, the cache invalidation repository may be an object storage service provided by a third-party.

The term “cache invalidation polling request” refers to a signal, data, and/or computer readable instructions transmitted and/or received by one or more computing devices, repositories, and/or the like, and that comprises, represents, indicates, and/or is associated with a request for cache invalidation messages. For example, a cache invalidation polling request may comprise a signal, data, and/or computer readable instructions periodically sent by a TCS sidecar to a cache invalidation repository requesting cache invalidation messages published to the cache invalidation repository.

The term “cache” refers to a storage component. A cache may be a high-speed storage component used to store frequently accessed data or instructions to, for example, facilitate quick retrieval. In some examples, a cache may be implemented using memory such as static random access memory (SRAM), embedded dynamic random access memory (eDRAM), or the like.

The term “tenant metadata” refers to objects, data, and/or the like required to locate and serve a client request to an application including, but not limited to, cloud-based applications.

The term “sidecar” refers to a co-process that runs alongside a client application. In some examples, a sidecar comprises a minor application deployed alongside a main application to provide additional capabilities and/or functionality including, but not limited to, low latency. A sidecar may be configured to serve client requests and may be run concurrently across multiple compute nodes/application nodes. A TCS sidecar is an example of sidecar.

The terms “TCS sidecar,” “client sidecar,” or similar terms refer to a co-process of a TCS that runs alongside an application (e.g., client application). For example, a TCS sidecar may be configured to replicate interactions an application associated with the TCS sidecar would otherwise have with the TCS associated with the TCS sidecar. In some examples, a TCS sidecar may function as an extension of web server cache (e.g., a temporary storage mechanism used by web servers to store and quickly retrieve frequently accessed data) in that a TCS sidecar is a co-process configured to provide similar long-lived in memory caches as the web server cache but running alongside client applications. In some embodiments, a TCS sidecar is configured to poll cache invalidation repositories associated with one or more TCS-es (e.g., parent TCS-es) for invalidation messages published by the one or more TCS-es. In some embodiments, a sidecar is configured to be in communication with the one or more TCS-es to, for example, evaluate the health of each TCS. In some embodiments, a sidecar is configured to select from the one or more TCS-es, a TCS for serving request traffic and cache invalidation streams. For example, a TCS sidecar may be configured to validate the current network connectivity by verifying whether certain keys exist in the TCS memory cache. In some examples, TCS sidecars may be configured to broadcast to each other. For example, a TCS sidecar may be configured to periodically announce the keyspace in the TCS cache to other sidecars in the same service group. In some embodiments, a TCS sidecar is configured to broadcast cache keys and cryptor keys between application nodes and/or between instances in a service. An example, of a TCS sidecar includes a SpringBoot application run inside a separate docker container running on an application node.

The term “sidecar cache invalidation” refers to a process where entries in a sidecar cache (e.g., TCS sidecar cache) are replaced or removed. For example, cache invalidation may occur when data stored in a TCS sidecar cache is modified or otherwise removed based on, for example, a cache invalidation message received directly or indirectly from an invalidation cache repository associated with the region associated with the TCS sidecar.

The term “cache invalidation message,” “invalidation broadcast messages” or similar terms refer to a message that indicates object, data, or the like (e.g., keys, signatures, and/or the like) in a cache has been modified or otherwise no longer valid. A cache invalidation message may include objects, data, and/or the like that may be leveraged to perform cache invalidation such as, for example, sidecar cache invalidation. In some embodiments, a cache invalidation message is generated in response to update to a tenant record in a tenant record repository. In some embodiments, a cache invalidation message may be published by a TCS cache invalidation server (e.g., via invalidation broadcaster nodes) to one or more cache invalidation repositories, where one or more TCS sidecars may poll for cache invalidation messages. In some embodiments, upon receiving a cache invalidation message, the TCS sidecar may trigger a background refresh of the corresponding key(s) if present in the TCS cache. In some examples, invalidation messages are accumulated in memory for a predetermined period (e.g., one second, two seconds, or the like) before publishing to a cache invalidation repository.

The term “client identifier” refers to one or more data items or elements by which a client may be uniquely identified. In some embodiments, a client includes a TCS sidecar and/or application or service associated with the TCS sidecar. The client identifier may include, for example, one or more of Internet Protocol (IP) addresses associated with a service, Uniform Resource Locators (URLs) associated with a service, numerical characters, alphabetical characters, alphanumeric codes, American Standard Code for Information Interchange (ASCII) characters, encryption keys, identification certificates, the like, or combinations thereof. In some embodiments, a client identifier comprises a role identifier and a role session name.

The term “sidecar registration request” refers to a signal, data, and/or computer readable instructions transmitted and/or received by one or more computing devices, repositories, and/or the like, and that comprises, represents, indicates, and/or is associated with a request to register a TCS sidecar with a TCS.

The term “sidecar registration” refers to a process where a TCS is configured to publish cache invalidation messages to a cache invalidation repository specified by a TCS sidecar (e.g., a cache invalidation repository associated with the region associated with the TCS sidecar).

The term “poll”, “polling” or similar terms refer to a process of checking the status of device, resource, or process at regular intervals. For example, polling may comprise periodically sending requests or queries to another component, device, or resource to determine its status, retrieve data, direct, instruct, and/or the like. Polling process may be implemented using software algorithms that execute on one or more processors within a computing system. In some examples, a polling mechanism may be integrated into operating systems, device drivers, application software, network protocols, and/or the like based on the context.

The term “cache invalidation stream” refer to a process configured to send cache invalidation messages or information to, for example, worker processes. By way of example, a cache invalidation stream may comprise or otherwise leverage a publish-subscribe model that utilizes message queues to efficiently propagate cache invalidation messages across nodes or services. A cache invalidation steam may be configured to ensure that relevant caches are promptly notified and can update or invalidate their local copies of shared data.

The term “worker process”, “worker” or similar terms refer to an independent execution unit within a large computing system or application. For example, a worker process may be a component in distributed and parallel computing architectures and may be configured to perform specific tasks or handle particular aspect of a system's workload. In some examples, a worker process may be implemented as a separate thread or process within a system, and may be managed by a central coordinator or scheduler. By way of example, in distributed systems, worker processes may run, for example, on different physical machines or virtual instances, communicating with each other and/or with a central coordinator through network protocols such as message queue systems, TCP/IP, or the like).

Thus, use of any such terms, as defined herein, should not be taken to limit the spirit and scope of embodiments of the present disclosure.

### Example System Architecture

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, some embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

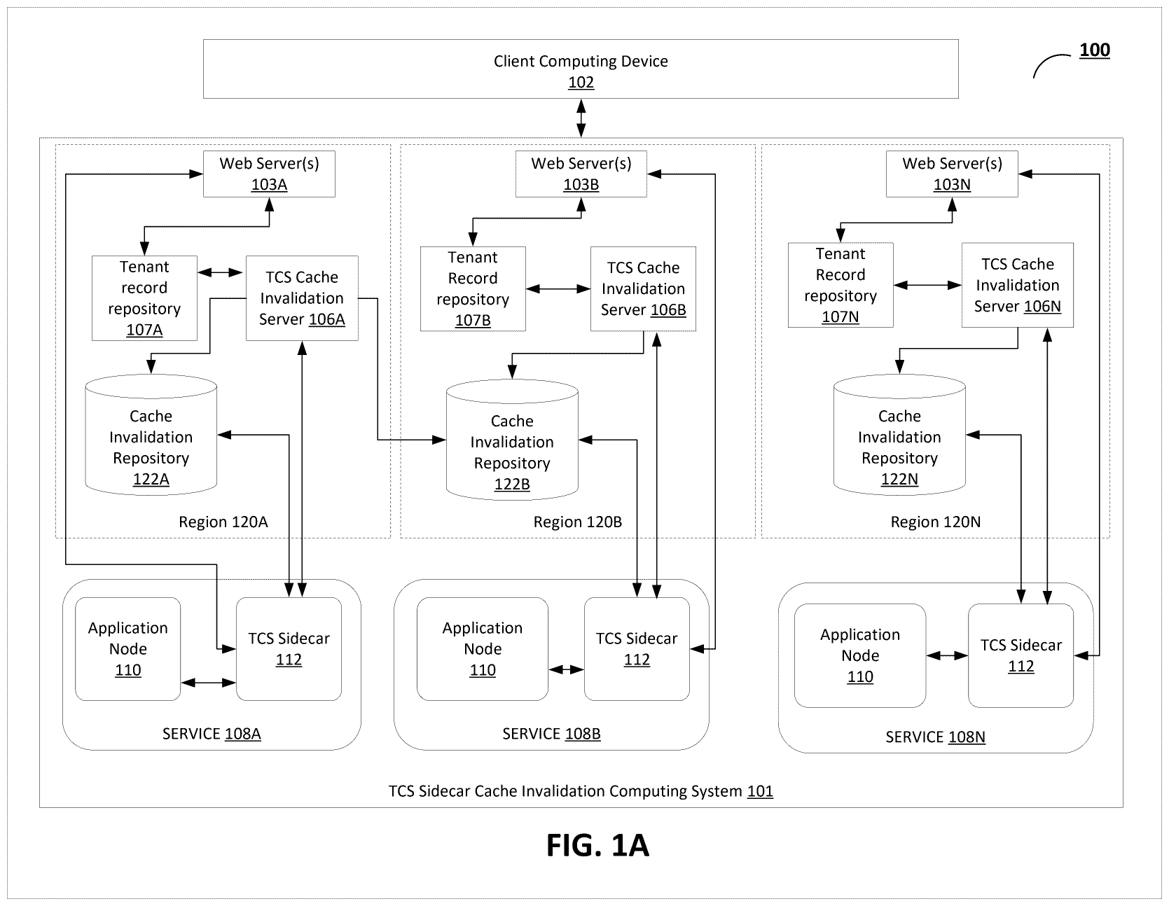

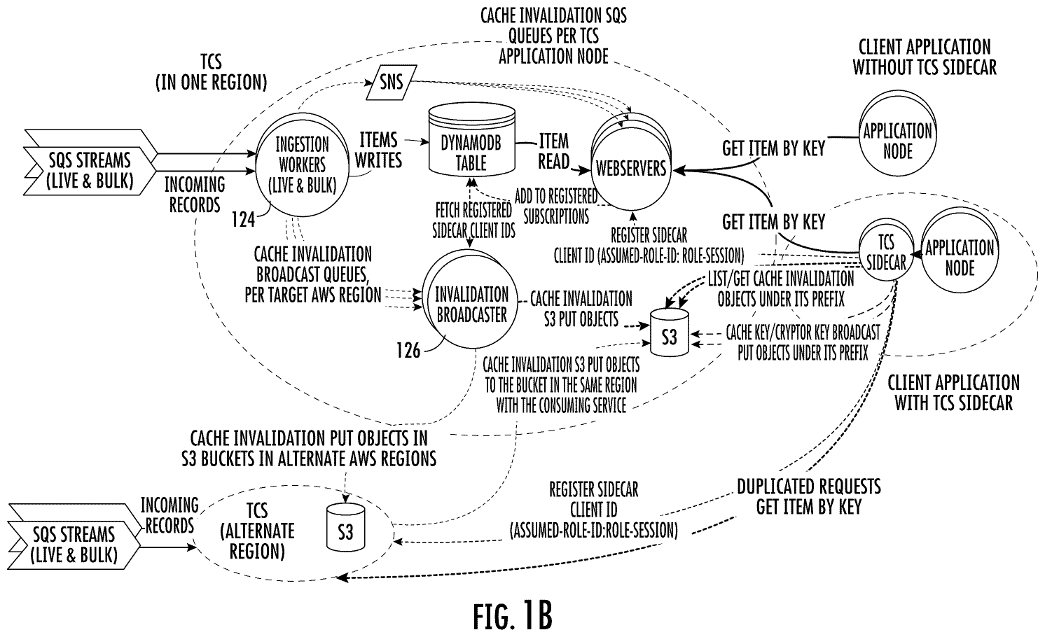

FIG. 1A provides an example tenant context service (TCS) sidecar cache invalidation system architecture 100 within which embodiments of the present disclosure may operate. The depiction of the example system architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1A and the system architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1A are shown as discrete, separate elements, other configurations may be used in connection with the methods, apparatuses, computer readable media, and computer programs described herein, including configurations that combine, omit, and/or add aspects and/or components.

As shown in FIG. 1A, the system architecture 100 includes a TCS sidecar cache invalidation computing system 101 and one or more client computing devices 102. In some embodiments, the functions of one or more of the illustrated components in FIG. 1A may be performed by a single computing device or by multiple computing devices, which devices may be local or cloud based. It will be appreciated that the various functions performed by the TCS sidecar cache invalidation computing system 101 and the one or more client computing devices 102 may be embodied by a single apparatus, subsystem, or system comprising one or more sets of computing hardware (e.g., processor(s) and memory) configured to perform the various functions thereof. For example, in some embodiments, one or more of the components of the TCS sidecar cache invalidation computing system 101 may be embodied by a client computing device 102.

The TCS sidecar cache invalidation computing system 101 may include one or more services 108A-N configured to provide one or more functionality or services (e.g., processing services, database storage services, infrastructure services, caching services, or other services). Each of the one or more services 108A-N may include an application node 110 and a TCS sidecar 112 associated with the application node 110.

Additionally, the TCS sidecar cache invalidation computing system 101 may include one or more TCS cache invalidation servers 106A-N, each communicatively coupled to a tenant record repository of one or more tenant record repositories 107A-N. As shown in FIG. 1A, each tenant record repository may be communicatively coupled to a web server of one or more web servers 103A-N. The TCS sidecar cache invalidation computing system 101 may further include one or more cache invalidation repositories 122A-N.

In some embodiments, and as shown in FIG. 1A, each of the one or more web servers 103A-N, one or more TCS cache invalidation servers 106A-N, one or more tenant record repositories 107A-N, and/or one or more cache invalidation repositories 122A-N may be associated with a particular region of a plurality of regions 120A-N. For example, each region of one or more regions 120A-N may include a set of components comprising a web server, a TCS cache invalidation server, a tenant record repository, and a cache invalidation repository.

A TCS cache invalidation server may be configured to receive cache invalidation messages and publish the cache invalidation messages to one or more cache invalidation repositories. A TCS sidecar 112 may be associated with a particular region and may be configured to poll (e.g., periodically send invalidation message polling request) cache invalidation repositories in the associated region for cache invalidation messages. The cache invalidation repositories may be configured to provide published cache invalidation messages to the TCS sidecars. The TCS sidecars may receive the published cache invalidation messages from the cache invalidation repository and process the cache invalidation messages (e.g., perform TCS sidecar cache invalidation based on the cache invalidation messages).

In some embodiments, a TCS cache invalidation server comprise or is associated with one or more ingestion workers 124 (as shown in FIG. 1B which illustrate an operational example of an implementation of at least a portion of a TCS sidecar cache invalidation system in accordance with at least some embodiments of the present disclosure) configured to ingest tenant records into a corresponding tenant record repository configured to store the tenant records. For example, an ingestion worker 124 may comprise a worker configured to handle intake and/or initial process of data such as intake of tenant records. In some examples, an ingestion worker 124 may be implemented as a dedicated software component running on one or more servers or cloud instances. In some examples, an ingestion worker 124 may utilize multi-threading or asynchronous input/output techniques to efficiently handle multiple data streams concurrently. The one or more ingestion workers 124 and/or TCS cache invalidation server may receive the tenant records from a cache invalidation stream which may be populated based on updates (e.g., originating from a client computing device 102) to tenant records. Such updates may include modification or deletion of tenant records. In some embodiments, a TCS cache invalidation server comprise or is associated with one or more invalidation broadcaster nodes 126 (See., FIG. 1B), where the TCS cache invalidation server may leverage the invalidation broadcaster node(s) to publish cache invalidation messages to invalidation cache repositories.

In some embodiments, a TCS cache invalidation server may be configured to receive sidecar registration requests from a TCS sidecar. The sidecar registration request may be a request to publish cache invalidation messages to cache invalidation repositories in a region associated with the TCS sidecar. In some embodiments, the sidecar registration request(s) may be received prior to receiving cache invalidation polling request(s), as described herein.

In some embodiments, a cache invalidation message may originate from a client computing device 102 or otherwise caused by a client computing device 102. For example, a cache invalidation message may be generated in response to updates, modifications, deletions, and/or the like to a tenant record via a client computing device 102.

In some embodiments, the cache invalidation repositories 122A-N may comprise an object oriented container for storing objects. For example, the cache invalidation repositories 122A-N may be configured to store data, such as tenant data, as objects within a container. An example of an invalidation repository is AWS S3 object-oriented container. For example, the cache invalidation repositories 122A-N may be implemented as S3 object-oriented containers in some example implementations.

The various components illustrated in the TCS sidecar cache invalidation computing system 101 and the system architecture 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In some embodiments, the components depicted in FIG. 1A as being included in the TCS sidecar cache invalidation computing system 101, although not required to be an integral system, may be connected via one or more networks. In some embodiments, one or more APIs may be leveraged to communicate with and/or facilitate communication between one or more of the components illustrated in the TCS sidecar cache invalidation computing system 101 and system architecture 100.

The cache invalidation repositories 122A-N may be associated with custom policies including allowing cross-account read/write for TCS-es; allowing services under the same account to list the root level of the cache invalidation repository to, for example, allow each service to list its own prefix; allowing a service to list versions, and get and put objects to its own prefix in accordance with a predefined format. In some examples, the predefined format may comprise {role-id}:{role session} which may correspond to a unique identifier, such as for example, “AssumeRoleId”, registered from a TCS sidecar to the TCS-es. By way of example, in an example S3 implementation, the custom policies may comprise or otherwise represented as:

```
- Effect: Allow
  Principal:
    AWS: ‘*’
  Action:
    - ‘s3:ListBucket’
    - ‘s3:ListBucketVersions’
  Resource:
    - { ‘Fn::Join’: [ “, [ ‘arn:aws:s3:::’, { Ref: Bucket } ] ] }
  Condition: {
    ArnLike: {
      ‘aws:PrincipalArn’: [ { ‘Fn::Sub’: ‘arn:aws:iam::${AWS::AccountId}:role/*’ } ]
    },
    StringEquals: {
      ‘s3:prefix’: [‘’],
      ‘s3:delimiter’: [‘/’]
    }
  }
- Effect: Allow
  Principal:
    AWS: ‘*’
  Action:
    - ‘s3:ListBucket’
    - ‘s3:ListBucketVersions’
  Resource:
    - { ‘Fn::Join’: [ “, [ ‘arn:aws:s3:::’, { Ref: Bucket } ] ] }
  Condition: {
    ArnLike: {
      ‘aws:PrincipalArn’: [ { ‘Fn::Sub’: ‘arn:aws:iam::${AWS::AccountId}:role/*’ } ]
    },
    StringLike: {
      ‘s3:prefix’: [ ‘*${aws:userid}/*’ ]
    }
  }
- Effect: Allow
  Principal:
    AWS: ‘*’
  Action:
    - ‘s3:GetObject’
    - ‘s3:GetObjectVersion’
    - ‘s3:PutObject’
  Resource: [ { ‘Fn::Join’: [ “, [ ‘arn:aws:s3:::’, { Ref: Bucket }, ‘/*${aws:userid}/*’ ] ] } ]
  Condition: {
    ArnLike: {
      ‘aws:PrincipalArn’: [ { ‘Fn::Sub’: ‘arn:aws:iam::${AWS::AccountId}:role/*’ } ]
    }
```

In some embodiments, TCS sidecars 112 may be configured to register with TCS to facilitate for invalidation broadcasts, as further described herein. In some embodiments, when a TCS sidecar 112 registers with a TCS for invalidation messages, in the request payload, it passes its region and unique identifier (e.g., “AssumeRoleId”) which may be called from a corresponding API at the sidecar startup. In some embodiments, the unique identifier may be prefixed with a hash (e.g., MD5 hash of itself) and suffixed with the subscribed TCS short name according to a predefined format.

### Example Apparatuses of the Disclosure

Having discussed example systems in accordance with the present disclosure, example apparatuses in accordance with the present disclosure will now be described.

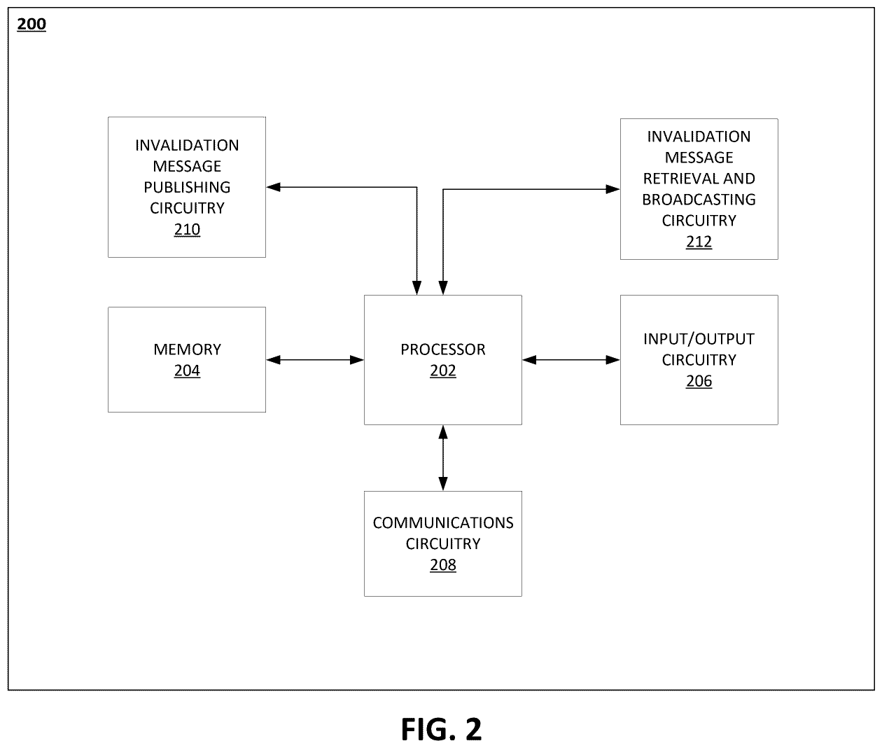

FIG. 2 illustrates a block diagram of an apparatus 200 in accordance with some example embodiments. For example, in some embodiments, TCS sidecar cache invalidation computing system 101 (or one or more portions thereof), if embodied in a particular embodiment, may be embodied by one or more apparatuses 200. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the functionality of the TCS sidecar cache invalidation computing system 101 or any subset thereof may be performed by a single apparatus 200 or multiple apparatuses 200. In some embodiments, the apparatus 200 may comprise one or a plurality of physical devices.

The apparatus 200 may include processor 202, memory 204, input/output circuitry 206, and communications circuitry 208, invalidation message publishing circuitry 210, and/or invalidation message retrieval and broadcasting circuitry 212. The apparatus 200 may be configured to execute the operations described herein. Although these components 202-212 are described with respect to functional limitations, it should be understood that the particular implementations necessarily include the use of particular hardware. It should also be understood that certain of these components 202-212 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

In some embodiments, the apparatus 200 includes an invalidation message publishing circuitry 210. The invalidation message publishing circuitry 210 may include hardware components, software components, and/or a combination thereof configured to, with the processor 202, memory 204, input/output circuitry 206 and/or communications circuitry 208, perform one or more functions associated with a TCS cache invalidation server 106A-N(as described above with reference to FIG. 1A). In some embodiments, the invalidation message publishing circuitry 210 may be configured to receive and/or transmit data, objects, and/or the like from and/or to one or more components of the apparatus 200, through, for example, the use of applications or APIs executed using a processor, such as the processor 202. It should also be appreciated that, in some embodiments, the invalidation message publishing circuitry 210 may include a separate processor, specially configured field programmable gate array (FPGA), or application specific interface circuit (ASIC) to provide or otherwise facilitate access to such data, objects, and/or the like used by one or more other components of the apparatus 200. The invalidation message publishing circuitry 210 may also provide for communication with other components of the apparatus, system and/or external systems via a network interface provided by the communications circuitry 208.

In some embodiments, the apparatus 200 includes an invalidation message retrieval and broadcasting circuitry 212. The invalidation message retrieval and broadcasting circuitry 212 may include hardware components, software components, and/or a combination thereof configured to, with the processor 202, memory 204, input/output circuitry 206 and/or communications circuitry 208, perform one or more functions associated with a service 108A-N and/or components thereof (e.g., TCS sidecar 112) (as described above with reference to FIG. 1A). In some embodiments, the invalidation message retrieval and broadcasting circuitry 212 may be configured to receive and/or transmit data, objects, and/or the like from and/or to one or more components of the apparatus 200, through, for example, the use of applications or APIs executed using a processor, such as the processor 202. It should also be appreciated that, in some embodiments, the invalidation message retrieval and broadcasting circuitry 212 may include a separate processor, specially configured field programmable gate array (FPGA), or application specific interface circuit (ASIC) to provide or otherwise facilitate access to such data, objects, and/or the like used by one or more other components of the apparatus 200. The invalidation message retrieval and broadcasting circuitry 212 may also provide for communication with other components of the apparatus, system and/or external systems via a network interface provided by the communications circuitry 208.

Additionally, or alternatively, in some embodiments, two or more of the sets of circuitries embodying processor 202, memory 204, input/output circuitry 206, communications circuitry 208, invalidation message publishing circuitry 210, and/or invalidation message retrieval and broadcasting circuitry 212 are combinable. Alternatively, or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208, invalidation message publishing circuitry 210, and/or invalidation message retrieval and broadcasting circuitry 212 are combined into a single module embodied in hardware, software, firmware, and/or a combination thereof. Similarly, in some embodiments, one or more of the sets of circuitry, for example, invalidation message publishing circuitry 210, and/or invalidation message retrieval and broadcasting circuitry 212 is/are combined with the processor 202, such that the processor 202 performs one or more of the operations described above with respect to each of these sets of circuitry embodied by invalidation message publishing circuitry 210, and/or invalidation message retrieval and broadcasting circuitry 212.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Client Computing Device

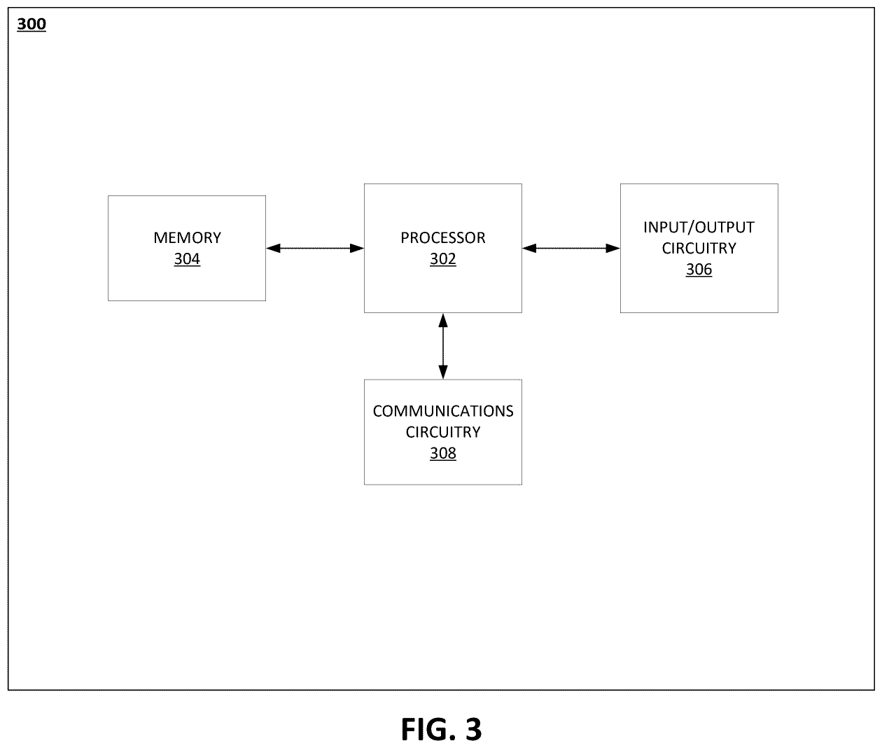

Referring now to FIG. 3, a client computing device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Exemplary Data Flows and Operations

As indicated, some embodiments of the present disclosure make important technical contributions to sidecar cache invalidation techniques. In particular, systems and methods are disclosed herein that implement a specially-configured sidecar cache invalidation process for improving traditional sidecar cache invalidations. By doing so, sidecar cache invalidation techniques described herein may provide an improvement in sidecar cache invalidations that may be practically applied to improve various computing tasks, including TCS cache invalidation and/or other sidecar cache invalidations tasks.

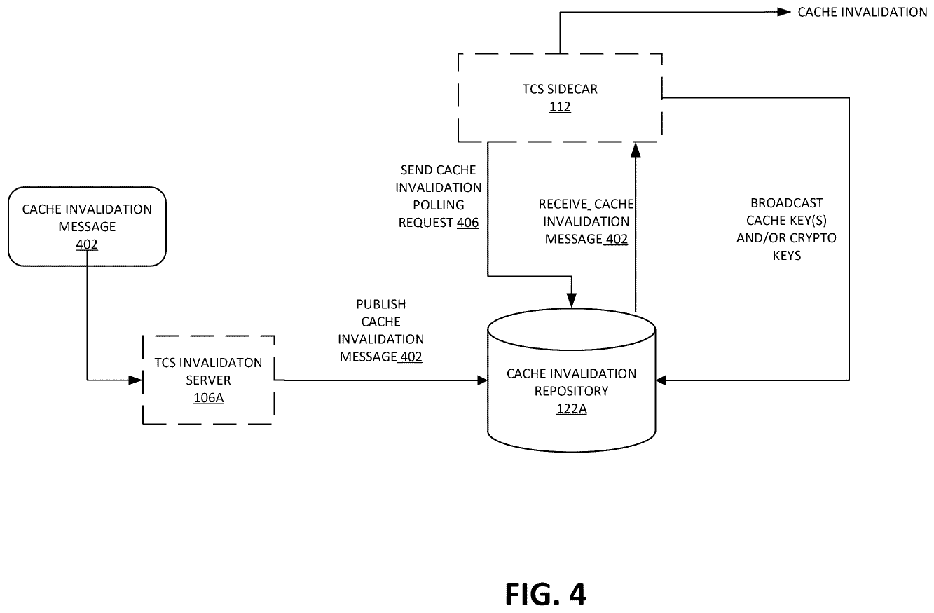

FIG. 4 illustrates a visualization of an example data environment for TCS sidecar cache invalidation in accordance with at least some embodiments of the present disclosure.

In some embodiments, a cache invalidation message 402 is received. In some embodiments, the cache invalidation message may be received in response to a cache invalidation event indication such as, but not limited to, updates to one or more tenant records. For example, a cache invalidation message 402 may be generated in response to modification, update, and/or the like to a tenant record. In some embodiments, the modification, update, and/or the like to the tenant record may originate from a client computing device 102. In some embodiments, the cache invalidation message 402 may be received by a TCS cache invalidation server (e.g., TCS 106A from the one or more TCS invalidation servers 106A-N) and/or associated invalidation broadcaster(s). In some embodiments, receiving the cache invalidation message comprises retrieving the cache invalidation message from a cache invalidation stream.

In some embodiments, a cache invalidation message is a message that indicates object, data, or the like (e.g., keys, signatures, and/or the like) in a cache has been modified or otherwise no longer valid. A cache invalidation message may include objects, data, and/or the like that may be leveraged to perform cache invalidation such as, for example, TCS sidecar cache invalidation. In some embodiments, a cache invalidation message is generated in response to update to a tenant record in a tenant record repository. In some embodiments, a cache invalidation message may be published by a TCS cache invalidation server (e.g., via invalidation broadcaster nodes 126) to one or more cache invalidation repositories, where one or more TCS sidecars may poll for cache invalidation messages (e.g., corresponding to cache invalidation events).

In some embodiments, upon receiving a cache invalidation message, the TCS sidecar may trigger a background refresh of the corresponding key(s) if present in the TCS cache. In some examples, cache invalidation messages are accumulated in memory for a predetermined period (e.g., one second, two seconds, or the like) before publishing to a cache invalidation repository.

In some embodiments, a TCS cache invalidation server is a server associated with a TCS and leveraged by the TCS to facilitate and/or perform one or more functions associated with TCS sidecar cache invalidations and/or broadcasting.

In some embodiments, a TCS is a service that is configured to provide a view of tenant metadata. A TCS lookup may be performed to serve a client request (e.g., request initiated by a client application or device). For example, a TCS may be called multiple times in the path of a web request associated with an application including, but not limited to a cloud-based application. A TCS may provide a highly-available, read-optimized view of a catalogue of tenant metadata. For example, a TCS may be key-value store (e.g., a database system/data structure that associates a unique key with a corresponding value) providing access to view current tenant state data stored in a catalogue service. In some embodiments, a TCS is configured to ingest (e.g., receive or similar terms) updated tenant records to a tenant record repository in response to changes to the tenant records, where the updated tenant records may be fetched (e.g., via a REST API, or the like) from the tenant record repository. In some embodiments, a TCS is associated with a particular region (e.g., identified by a region identifier) of a plurality of regions. In some embodiments, a TCS may be associated with one or more TCS sidecars and may configured to publish invalidation messages for access by the one or more TCS sidecars.

In some embodiments, a TCS sidecar is a co-process of a TCS that runs alongside an application (e.g., a client application). For example, a TCS sidecar may be configured to replicate interactions an application associated with the TCS sidecar would otherwise have with a TCS. In some examples, a TCS sidecar may function as an extension of web server cache in that a TCS sidecar is a co-process configured to provide similar long-lived in memory caches as the web server cache but running alongside client applications. In some embodiments, a TCS sidecar is configured to poll cache invalidation repositories associated with one or more TCS (e.g., parent TCS) for invalidation messages published by the one or more TCS. In some embodiments, a sidecar is configured to be in communication with the one or more TCS to, for example, evaluate the health of each TCS. In some embodiments, a sidecar is configured to select from the one or more TCS, a TCS for serving request traffic and cache invalidation streams. For example, a TCS sidecar may be configured to validate the current network connectivity by verifying whether certain keys exist in the TCS memory cache. In some examples, TCS sidecars may be configured to broadcast to each other. For example, a TCS sidecar may be configured to periodically announce the keyspace in the TCS cache to other sidecars in the same service group.

In some embodiments, the cache invalidation message 402 is published to a cache invalidation repository. In some embodiments, the cache invalidation message 402 may be published by the TCS invalidation sever that received the cache invalidation message 402. In some embodiments, the cache invalidation message 402 may be published to the cache invalidation repository based on the region identifier associated with the cache invalidation repository. For example, the cache invalidation message may be configured to publish the cache invalidation message to one or more cache invalidation repositories based on the region identifier associated with the one or more cache invalidation repositories. For example, the cache invalidation message 402 may be published to cache invalidation repositories having the same region identifier as TCS sidecars registered with or otherwise associated with the TCS cache invalidation server publishing the cache invalidation message. For example, the invalidation message may or may not be published across regions depending on the sidecars registered with or otherwise associated with the TCS sidecar. In some embodiments, publishing the cache invalidation message 402 to a cache invalidation repository comprises storing one or more objects, data, keys, signatures, and/or the like associated with a tenant record. In some embodiments, the cache invalidation message is stored in a memory for at least a predetermined period before publishing to the cache invalidation repository.

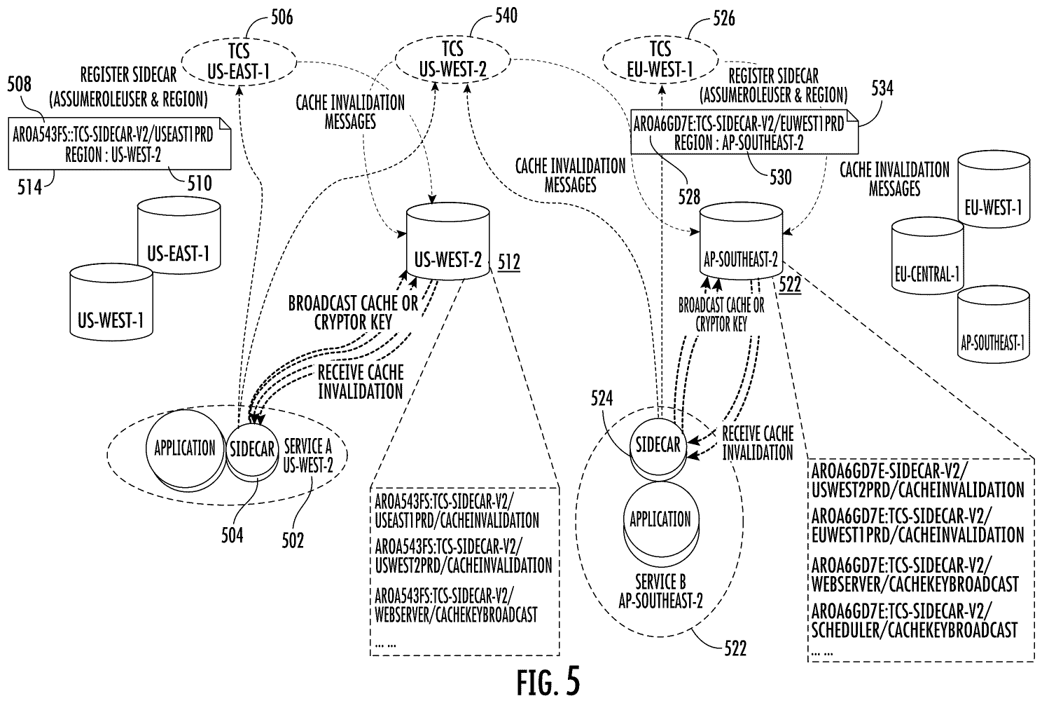

In this regard, in some embodiments, as further described below with reference to FIG. 5, the one or more cache invalidation repositories in which a cache invalidation message 402 is published depends at least in part on the service(s) registered with the TCS cache invalidation server publishing the cache invalidation message 402.

In some embodiments, the cache invalidation message is stored in a memory (e.g., a memory associated with the TCS server or other components of the TCS sidecar cache invalidation computing system 101) for at least a predetermined period (e.g., one second, two seconds, or the like) before publishing to a cache invalidation repository.

In some embodiments, a region identifier is one or more data items or elements by which a region (e.g., geographical area) may be uniquely identified. In some embodiments, the region identifier is a TCS region identifier that uniquely identifies a TCS region (e.g., a TCS geographical area). The region identifier may include, for example, one or more of Internet Protocol (IP) addresses associated with a service, Uniform Resource Locators (URLs) associated with a service, numerical characters, alphabetical characters, alphanumeric codes, American Standard Code for Information Interchange (ASCII) characters, encryption keys, identification certificates, the like, or combinations thereof. Not limiting examples of TCS region includes us cast-1, us cast-2 us-west 1, and/or the like. In some embodiments, each region identifier of a plurality of region identifiers is associated with at least one dedicated cache invalidation repository for the region identifier.

In some embodiments, a TCS region is a geographical area hosting one or more computing resources (e.g., storage, compute, and/or the like) separate from computing resources hosted by other geographical areas. For example, each TCS region may be a separate geographical area hosting cloud computing resources. In some examples, the computing resources hosted by a TCS region may be distributed across a plurality of isolated locations within the geographical area associated with the TCS region. In some embodiments, each TCS region is independent of other TCS regions. In some embodiments, a TCS region includes or is associated with one or more cache invalidation repositories configured for facilitating sidecar cache invalidation process. For example, a cache invalidation repository associated with a particular TCS region may be leveraged to facilitate TCS cache invalidation for a TCS sidecar served by the TCS region or otherwise associated with the TCS region.

In some embodiments, a cache invalidation repository is a repository configured to store objects, data, and/or the like. In some embodiments, the cache invalidation repository is configured to store cache invalidation messages. In some embodiments, a cache invalidation repository is configured to receive cache invalidation messages published by a TCS. A cache invalidation repository may be configured to receive invalidation polling request from a service (e.g., TCS sidecar thereof) for cache invalidation messages published by a TCS cache invalidation server and provide the cache invalidation messages to the TCS sidecar associated with the service. In some embodiments, the cache invalidation repository is configured to receive cache keys and/or cryptor keys broadcast by a TCS sidecar in the same region. In some embodiments, a cache key comprise a unique identifier used to store and retrieve data in a cache/cache system such as a sidecar cache or other caches. In some embodiments, a cryptor key comprise cryptographic information used to secure and protect data, such as data stored in cache/cache system (e.g., sidecar cache or other caches). An example of a cache invalidation repository is an AWS S3 object-oriented container. For example, the cache invalidation repository may be an object storage service provided by a third-party.

In some embodiments, a cache invalidation polling request 406 is received from a service associated with the region identifier via, for example, a TCS sidecar associated with the service. For example, the TCS sidecar associated with the service may be configured to poll (e.g., periodically request) one or more cache invalidation repositories for cache invalidation messages.

In some embodiments, the cache invalidation polling request 406 is a signal, data, and/or computer readable instructions transmitted and/or received by one or more computing devices, repositories, and/or the like, and that comprises, represents, indicates, and/or is associated with a request for cache invalidation messages. For example, the cache invalidation polling request 406 may comprise checking if a cache invalidation message has been published to a cache invalidation repository.

In some embodiments, the cache invalidation message 402 is provided to the service via the TCS sidecar. In some embodiments, a TCS sidecar cache invalidation operation is performed by the TCS sidecar based on the cache invalidation message 402. In some embodiments, providing the cache invalidation message 402 to a sidecar comprises providing one or more objects, data, keys, signatures, and/or the like associated with a tenant record.

In some embodiments, a sidecar cache invalidation is a process where entries in a sidecar cache are replaced or removed. For example, cache invalidation may occur when data stored in a TCS sidecar cache is modified or otherwise removed based on, for example, a cache invalidation message received directly or indirectly from an invalidation cache repository serving a region associated with the TCS sidecar.

In some embodiments, a TCS sidecar may be configured to broadcast (e.g., via cache invalidation repositories 122A-N), cache keys and/or a cryptor keys to other TCS sidecars, between application nodes, and/or between instances in a service. For example, the TCS sidecar 112 may broadcast cache keys and/or cryptor keys maintained in the TCS sidecar cache to the cache invalidation repository 122A, where another TCS sidecar, application node, and/or the like may retrieve or otherwise access the broadcasted cache key and/or cryptor key in the cache invalidation repository.

FIG. 5 illustrates a block diagram of TCS sidecar registration process in accordance with at least some example embodiments of the present disclosure. As shown in FIG. 5, a service may register with one or more TCS-es for cache invalidation messages, such that a TCS sidecar associated with the service may receive, via a cache invalidation repository, cache invalidation messages published by the one or more TCS-es.

In some embodiments, a sidecar registration request is a signal, data, and/or computer readable instructions transmitted and/or received by one or more computing devices, repositories, and/or the like, and that comprises, represents, indicates, and/or is associated with a request to register a TCS sidecar with a TCS. In some embodiments, a sidecar registration is a process where a TCS is configured to publish cache invalidation messages to a cache invalidation repository specified by a TCS sidecar (e.g., a cache invalidation repository associated with the region associated with the TCS sidecar).

In some embodiments, registering a TCS sidecar with a TCS includes providing a unique identifier associated with the TCS sidecar and a region identifier associated with a cache invalidation repository, which the sidecar will poll for cache invalidation messages. In some embodiments, the unique identifier comprising a role identifier and a role session name.

The TCS with which the sidecar registered may publish cache invalidation messages to the cache invalidation repository associated with the specified region identifier, whereby the sidecar may be provided cache invalidation messages published to the cache invalidation repository when requested.

As shown in the example depicted in FIG. 5, TCS sidecar 504 associated with service A 502 may register with TCS 506 with a unique identifier 508 and region identifier 510 for the cache invalidation repository 512. For example, a TCS sidecar registration request 514 comprising the unique identifier 508 and region identifier 510 may be transmitted to the TCS 506 to register the TCS sidecar 504. As shown in FIG. 5, upon a successful registration, TCS sidecar 504 may begin to receive cache invalidation messages published to the cache invalidation repository 512. In this regard, in some embodiments, sidecar registration request(s) may be received prior to receiving cache invalidation polling request(s).

As further shown in the example depicted in FIG. 5, TCS sidecar 524 associated with service B 522 may register with TCS 526 with a unique identifier 528 and region identifier 530 for the cache invalidation repository 512. For example, a TCS sidecar request 534 comprising the unique identifier 528 and region identifier 530 may be transmitted to the TCS 526 to register the TCS sidecar 504. As shown in FIG. 5, upon a successful registration, TCS sidecar 504 may begin to receive cache invalidation messages published in the cache invalidation repository 512.

As shown in FIG. 5, a TCS sidecar may be registered with a plurality of TCS-es. For example, in the illustrated example of FIG. 5, TCS sidecar 504 is registered with both TCS 506 and TCS 540. As further shown in FIG. 5, TCS sidecar 524 is registered with both TCS 526 and TCS 540.

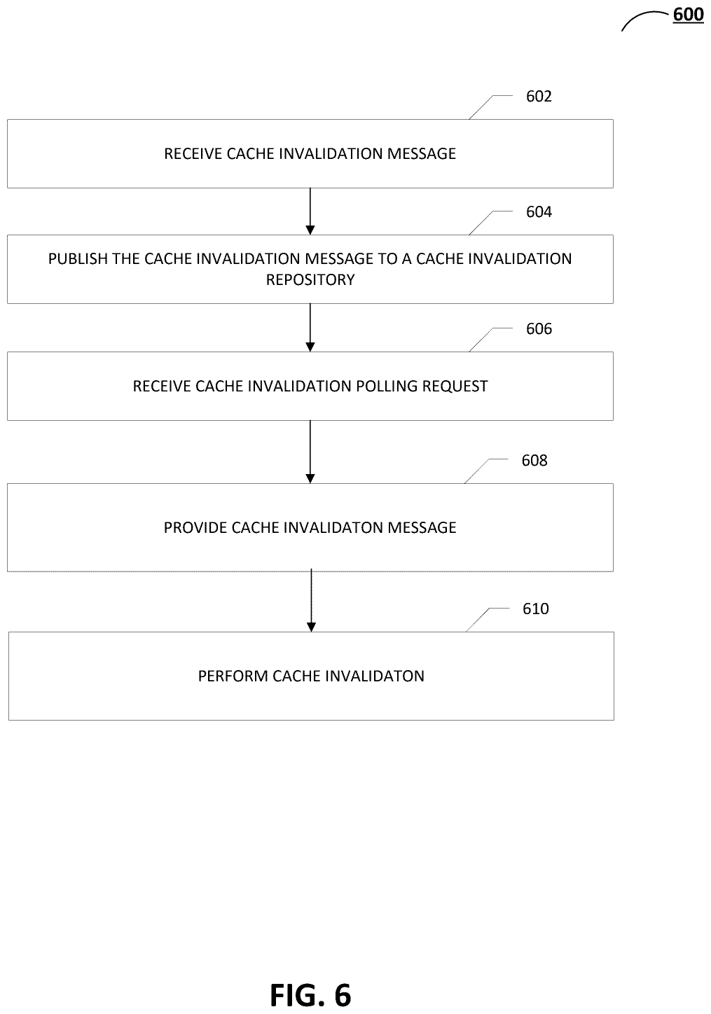

FIG. 6 is a flowchart diagram of an example process 600 for TCS sidecar cache invalidation in accordance with some embodiments discussed herein. The process 600 may be implemented by one or more computing devices, entities, and/or systems described herein. For example, via the various steps/operations of the process 600, the apparatus 200 may leverage various techniques, including but not limited, to cache invalidation message polling techniques for sidecar cache invalidation.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, receiving a cache invalidation message. For example, the apparatus (e.g., invalidation message publishing circuitry 210 thereof) may receive a cache invalidation message. In some embodiments, the cache invalidation message may be received in response to a cache invalidation event indication such as, but not limited to, updates, modification, deletion, and/or the like to one or more tenant records. In some embodiments, receiving the cache invalidation message comprises retrieving the cache invalidation message from a cache invalidation stream.

In some embodiments, the process 600 includes at step/operation 604 publishing the cache invalidation message to a cache invalidation repository. For example, the apparatus 200 (e.g., invalidation message publishing circuitry 210 thereof) may publish the received cache invalidation message to a cache invalidation repository based on the region identifier associated with the cache invalidation repository. For example, the apparatus 200 may publish the cache invalidation message to cache invalidation repository associated with a region specified by or otherwise associated with a TCS sidecar registered with the TCS cache invalidation server that received and/or is publishing the cache invalidation message. In some embodiments, the cache invalidation message is stored in a memory for at least a predetermined period before publishing to the cache invalidation repository.

In some embodiments, the process 600 includes at step/operation 606 receiving a cache invalidation polling request. For example, the apparatus 200 (e.g., invalidation message retrieval and broadcasting circuitry 212 thereof) may receive a cache invalidation polling request from a sidecar associated with the same region identifier as the cache invalidation repository via a sidecar associated with the service. For example, the sidecar associated with the service may be configured to periodically request (e.g., poll) one or more cache invalidation repositories for cache invalidation messages.

In some embodiments, the process 600 includes at step/operation 608 providing the invalidation message to a service (e.g., sidecar associated with the service). For example, the apparatus 200 (e.g., invalidation message retrieval and broadcasting circuitry 212 thereof) may provide the cache invalidation message to the sidecar associated with the service.

In some embodiments, the process 600 includes at step/operation 610 performing a sidecar cache invalidation. For example, the apparatus (e.g., invalidation message retrieval and broadcasting circuitry 212 thereof) may perform, based on the cache invalidation message, a TCS sidecar cache invalidation.

In some embodiments, a TCS sidecar may broadcast cache keys and/or cryptor keys to other sidecars associated with the service or in the same service group as the sidecar. For example, a TCS sidecar may be configured to broadcast cache keys and/or cryptor keys currently stored by the sidecar to at least a second sidecar associated with the service. In some embodiments, a TCS sidecar may be configured to broadcast cache keys and/or cryptor keys between application nodes and/or between instances in a service.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates a limited interaction mode and/or a non-limited interaction mode for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language page), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending pages to and receiving pages from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### CONCLUSION

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for sidecar cache invalidations in a tenant context service architecture, the computer-implemented method comprising:
receiving a cache invalidation message;
publishing the cache invalidation message to a cache invalidation repository based on a region identifier of a plurality of region identifiers associated with the cache invalidation repository;
receiving a cache invalidation polling request from a service associated with the region identifier; and
providing, the cache invalidation message to the service associated with the region identifier.

2. The computer-implemented method of claim 1, wherein receiving the cache invalidation polling request from the service comprises receiving the cache invalidation polling request from a sidecar associated with the service.

3. The computer-implemented method of claim 2, further comprising broadcasting a cache key currently stored by the sidecar to at least a second sidecar associated with the service.

4. The computer-implemented method of claim 1, further comprising receiving a sidecar registration request comprising the region identifier prior to receiving the cache invalidation polling request.

5. The computer-implemented method of claim 4, wherein the sidecar registration request further comprises a client identifier, wherein the client identifier comprises a role identifier and a role session name.

6. The computer-implemented method of claim 1, wherein each region identifier of the plurality of region identifiers is associated with at least one dedicated cache invalidation repository for the region identifier.

7. The computer-implemented method of claim 1, wherein the service comprises a tenant context service sidecar.

8. The computer-implemented method of claim 1, wherein receiving the cache invalidation message comprises retrieving the cache invalidation message from a cache invalidation stream, wherein the cache invalidation message is stored in a memory for at least a predetermined period before publishing to the cache invalidation repository.

9. An apparatus for sidecar cache invalidations in a tenant context service architecture, the apparatus comprising at least one processor and at least one memory including program code, the at least one memory and the program code configured to, with the at least one processor, cause the apparatus to at least:
receive a cache invalidation message;
publish the cache invalidation message to a cache invalidation repository based on a region identifier of a plurality of region identifiers associated with the cache invalidation repository;
receive a cache invalidation polling request from a sidecar associated with a service, wherein the service is associated with the region identifier; and
provide, the cache invalidation message to the service associated with the region identifier.

10. The apparatus of claim 9, wherein the at least one memory and the program code is further configured to, with the at least one processor, cause the apparatus to at least:
broadcast a cache key currently stored by the sidecar to at least a second sidecar associated with the service.

11. The apparatus of claim 9, wherein the at least one memory and the program code is further configured to, with the at least one processor, cause the apparatus to at least:
receive a sidecar registration request comprising the region identifier prior to receiving the cache invalidation polling request.

12. The apparatus of claim 11, wherein the sidecar registration request further comprises a client identifier, wherein the client identifier comprises a role identifier and a role session name.

13. The apparatus of claim 9, wherein each region identifier of the plurality of region identifiers is associated with at least one dedicated cache invalidation repository for the region identifier.

14. The apparatus of claim 9, wherein the service comprises a tenant context service sidecar.

15. The apparatus of claim 9, wherein receiving the cache invalidation message comprises retrieving the cache invalidation message from a cache invalidation stream, wherein the cache invalidation message is stored in a memory for at least a predetermined period before publishing to the cache invalidation repository.

16. At least one non-transitory computer-readable storage medium for sidecar cache invalidations in a tenant context service architecture, the at least one non-transitory computer-readable storage medium having computer coded instructions configured to, when executed by at least one processor:
receive a cache invalidation message from a cache invalidation message stream;
publish the cache invalidation message to a cache invalidation repository based on a region identifier of a plurality of region identifiers associated with the cache invalidation repository;
receive a cache invalidation polling request from a service associated with the region identifier; and
provide, the cache invalidation message to the service associated with the region identifier.

17. The at least one non-transitory computer-readable storage medium of claim 16, wherein receiving the cache invalidation polling request from the service comprises receiving the cache invalidation polling request from a sidecar associated with the service.

18. The at least one non-transitory computer-readable storage medium of claim 17, wherein the computer coded instructions further configured to, when executed by the at least one processor:
broadcast a cache key currently stored by the sidecar to at least a second sidecar associated with the service.

19. The at least one non-transitory computer-readable storage medium of claim 18, wherein the computer coded instructions further configured to, when executed by the at least one processor:
receive a sidecar registration request comprising the region identifier prior to receiving the cache invalidation polling request.

20. The at least one non-transitory computer-readable storage medium of claim 16, wherein each region identifier of the plurality of region identifiers is associated with at least one dedicated cache invalidation repository for the region identifier.
